(19) United States
(12) Patent Application Publication
(10) Pub. No.: US 2024/0426850 A1
(43) Pub. Date: Dec. 26, 2024

(54) DEVICES AND METHODS TO DETERMINE WHETHER TO CALIBRATE A LABORATORY ANALYZER

(71) Applicant: CCQCC Corp., Edmonton (CA)

(72) Inventors: George S. Cembrowski, Edmonton (CA); Christopher McCudden, Ottawa (CA)

(21) Appl. No.: 18/233,753

(22) Filed: Aug. 14, 2023

Related U.S. Application Data
(60) Provisional application No. 63/522,700, filed on Jun. 22, 2023.
(60) Provisional application No. 63/522,396, filed on Jun. 21, 2023.

(51) Int. Cl. G01N 35/00

(52) U.S. Cl. CPC G01N 35/00623; G01N 35/00693; G01N 35/00712; G01N 2035/00653

(57) ABSTRACT

Systems, apparatuses, and methods detect an error in a laboratory analyzer. A method can include determining a time delta between consecutive measurements of an analyte made on a patient using a laboratory analyzer, determining whether the time delta is within a specified number of days window, a specified time of day window, and is within a same season, determining a measurement value delta between the first and second measurements of the consecutive measurements if the time delta is within the specified number of days, time of day windows, and the same season, calculating an average of deltas, the average of deltas including a measurement value delta between the consecutive measurements, determining whether the average of deltas is within a specified range of acceptable average of delta values, and issuing an alert if the average of deltas is not within the specified range of acceptable average of delta values.

### RELATED APPLICATIONS

This application claims the benefit of priority to U.S. Provisional Patent Application 63/522,396 titled “Patient Centered Quality Control Analysis: Detecting presumptive random and systematic analytical error in sequential intra-patient results followed by evaluation of all available contemporaneous quality control results and/or reanalysis on an alternate analyzer” and filed on Jun. 21, 2023 and U.S. Provisional Patent Application 63/522,700 titled “Patient Centered Quality Control Analysis: Detecting presumptive random and systematic analytical error in sequential intra-patient results followed by evaluation of all available contemporaneous quality control results and/or reanalysis on an alternate analyzer” and filed on Jun. 22, 2023, the contents of both of which are incorporated herein by reference in their entireties.

### TECHNICAL FIELD

Embodiments in this disclosure generally relate to devices and methods for detecting error in a clinical laboratory analyzer, such as to determine whether the analyzer needs maintenance, such as calibration. Embodiments enable quality control (QC) in diverse laboratory environments including chemistry and hematology laboratories engaged in referral and outpatient clinical laboratory testing.

### BACKGROUND

It is estimated that as much as eight hundred fifty billion dollars is spent on needless medical procedures each year in the United States. One or more methods or devices discussed herein may help reduce the amount of money spent on wasteful medical procedures.

Interest in patient-based quality control (PBQC) has increased over the last decade, usually in the form of patient moving averages (MA). MA can detect transient or sustained shifts in the absence of traditional quality control (QC) analysis. While MA and other PBQC techniques will not replace traditional QC, PBQC may eventually reduce traditional QC frequency. PBQC does not require analysis of stabilized control materials and, importantly, does not exhibit non-commutability of many QC materials.

People have been using MA to detect systematic error (SE) (e.g., shifts or drifts) and found it to be of value, but also have found that MA is challenged by non-symmetrical patient distributions.

Many laboratories employ delta (difference) checks in which current values are compared to previous values from the same patient to detect sample mislabels and analytical error. Differences (deltas) greater than expected indicate more than the expected intra-patient variation, which comprises 1) patient biologic variation, 2) preanalytic variation, and 3) analytic variation. Published evaluations of delta check's error-detection capabilities demonstrate limited utility, being best suited to detecting large analytical errors or mislabeled specimens.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 illustrates the effect of added error (random or systematic) on the distribution of QC specimens, surrogates of highly stable patient specimens.

FIG. 2 illustrates, by way of example, a diagram of a graph of troponin QC results from three different laboratory analyzers.

FIG. 3 illustrates, by way of example, a graph of a test-ordering pattern of hemoglobin A1c (HbA1c), used to monitor diabetes control, generally in outpatients.

FIG. 4 illustrates, by way of example, a graph of frequency of intervals between consecutive lithium requests.

FIGS. 5-8 illustrate, by way of example, respective graphs of the results of analyzing five years of patient data.

FIG. 9 illustrates, by way of example, a graph of a frequency histogram of daily number of AST, ALT, and Na repeated tests after an initial test.

FIG. 10 illustrates, by way of example, a graph of a number of patient pairs per day for potassium over the entire five years of data.

FIG. 11 illustrates, by way of example, graphs of a running Dahlberg analysis using Equation 1 generating a continuous running average of the last 20 random variation estimates.

FIG. 12 illustrates, by way of example, a block diagram of an embodiment of a system to determine if a laboratory analyzer requires just recalibration or a more complete investigation, which usually includes recalibration.

FIG. 13 illustrates, by way of example, a flow diagram of an embodiment of a method of determining if a laboratory analyzer is to be calibrated.

FIG. 14 illustrates, by way of example, a diagram of a system for scheduling an analyte measurement in a manner that helps minimize biologic variation between sequential samples.

FIG. 15 illustrates, by way of example, a block diagram of an example of a device upon which any of one or more processes (e.g., methods) discussed herein can be performed.

### DESCRIPTION OF EMBODIMENTS

Embodiments in this disclosure relate generally to detecting error in a laboratory analyzer. Methods, systems, or devices in accord with this disclosure may help in determining if a laboratory analyzer should be calibrated or otherwise requires an adjustment. Methods, systems, or devices in accord with this disclosure may help in determining the appropriateness of re-analyzing a specimen associated with an analyzer error signal.

Modern laboratory equipment (e.g., chemistry and hematology analyzers, or the like) should be precise and accurate. Laboratory analyzers may be calibrated with calibrating solutions where the calibration can be verified by an analysis of quality control (QC) specimens. If the laboratory analyzer returns the value that is expected for the control specimen within a specified tolerance, then the laboratory analyzer is considered calibrated. If not, then operation of the laboratory analyzer is investigated, possibly repaired, and may be re-calibrated so that the analyzer returns quality control results within the specified tolerance. On such systems, once the analysis of one or more quality control specimens confirms that an analytical run is accurate, the laboratorian generally assumes that the prevalence of analytically defective testing is very low. For this reason, QC specimens may be analyzed infrequently. QC specimen analysis is often used to confirm the expected absence of analytical shifts and increased random error and not to detect error. With analytic errors that are episodic (e.g., periodic and/or transient), it is possible that quality control results may be within tolerance specifications, while preceding and/or subsequent analyses are defective but not detected. This problem of undetected error may be attributed to infrequent control analyses.

To detect these intermittent errors, QC specimens might be analyzed more frequently. Such a solution requires scheduling more tests on laboratory analyzers that may include an already full schedule, thus increasing costs and reducing the availability of the laboratory analyzer. This solution may be expensive in terms of delays in reporting of the patient results, the additional QC material consumed, the additional test reagents consumed, and the technologist's time and effort in the follow-up of any outlying data that are detected during the analysis of the additional QC specimens.

Another solution to detect the intermittent errors may include using an adequately sensitive and specific patient data analysis technique to detect an error in a laboratory analyzer. One such technique includes monitoring inter-patient medians or averages and deviations therefrom. Such techniques may provide details regarding a distribution of patient data and characteristics of the distribution. Various data reduction schemes have been used to provide averages or medians of truncated (e.g., trimmed) patient results. Unfortunately, while the deviation of patient results from the usual average or median can signal an analytic shift, it can also indicate a change in patient constituency, an analytic bias, or a combination thereof. Another disadvantage of such median or average tracking is that it detects an analytic shift or a systematic error but does not detect an increase in random error.

About fifty years ago, Hoffman and Waid introduced the average of normal (AON) QC method in their paper titled “The ‘average of normals’ method of quality control”. Using AON, test results that are determined to be within a “normal” range of expected results (e.g., within a certain standard deviation of average) were averaged and that average was used to monitor changes in the laboratory equipment and/or process of analyzing specimens. Using AON either no error condition exists (patient average was within limits) or an error exists (patient average is outside of limits and presumably due to an analytical shift with the average of the results either increased or decreased). As laboratory results outside their usual limits tend to be repeated more often than normal results, Hoffman and Waid recommended that only results within the normal range be averaged.

In 1984, Cembrowski et al assessed AON as an analysis tool in the publication titled “Assessment of ‘average of normals’ quality control procedures and guidelines for implementation.” The simulations performed by Cembrowski showed that AON reliability depends on a number of factors such as number of samples divided by an analytical standard deviation (Sa) (i.e. the standard deviation inherent in the analysis procedure), a width of the range considered of samples considered “normal” samples, the number of “normal” samples used in determining the average after truncating samples outside of the normal range, and the range of the control limits for the average of the normal samples.

One of the most popular approaches to hematology QC is Bull's approach (also known as Xb, pronounced “x bar b”) which uses a unique average of sequential batches of twenty patient red cell indices to demonstrate (in) stability in red cell associated Coulter measurements. The red cell indices consist of the directly measured mean corpuscular volume (MCV), the mean corpuscular hemoglobin calculated from hemoglobin (Hgb) and red blood cell (RBC) count, and the mean corpuscular hemoglobin concentration (MCHC) derived from Hgb, RBC and MCV. Too often, especially with today's highly precise hematology analyzers, these outlying average indices in hospital patients indicates the analysis of nonrandomized selection of patients with a high proportion of abnormal indices including neonates, renal failure patients or oncology patients undergoing chemotherapy.

In the 1980's and 1990's, review of QC every twenty specimens may have had significant utility. Today, however, many more samples are being analyzed and QC review every twenty samples is cumbersome. To decrease the implicit variation of the patient average and to improve its error signaling, it may be intuitive to average more specimens. In an evaluation of patient averages, it was determined that the error-detection capabilities of patient averages depend on multiple factors with the most important being the number of patient results averaged (N) and the ratio of the standard deviation of the patient population (sp) to the standard deviation of the analytical method (sa). Other important factors included the limits for evaluating the mean (control limits), the limits for determining which patient data are averaged (truncation limits), and the magnitude of the population lying outside the truncation limits.

In one or more embodiments, it can be beneficial to prevent the averaging of specimens with outlying results. For example, in a referral laboratory which analyzes primarily specimens from generally healthy patients, the occasional incorporation of blood from a patient with renal failure or chemotherapy will not affect the patient mean if proper truncation limits are implemented.

To monitor laboratory analyzers, either middleware or the analyzer's own software can be programmed to refrain from averaging patients from specific units (renal failure, oncology) or patients of specific ages (i.e., the neonate). Before averaging, to reduce the effect of the more frequent testing of outlying abnormal results, these data can be excluded (truncated) from averaging.

In modern day applications of averages of patient data, intermittent transient shifts in the patient averages can largely be ignored. The trouble-shooting of persistently shifted patient averages can incorporate assessment of preanalytical as well as post analytical (e.g., laboratory information) issues. The laboratorian should understand the clinical reasons for shifts in the patient averages before assuming analytical error and adjusting analyzer parameters. It is not always clear to laboratory staff whether a persistent shift is due to a subtle patient population shift or an altered analytical process. As such, the investigation of persistent outlying patient averages can be problematic. Techniques that employ patient averaging techniques may not easily detect random error.

Stability in the laboratory results of hospital patients can be seen in patients that are sampled (and analyzed) only once per day, such as between 0400 and 1200 hours in many hospitals. This stability arises from at least two different independent mechanisms: 1) for many laboratory tests, there is an implicit diurnal variation, so sampling and analyzing them on a 24 hour basis will tend to cause the least variation in their sequential results; and 2) in hospitals, patient acuity of illness is associated with more frequent testing. Thus, generally, only more stable patients will be sampled about once per 24 hours. The testing can occur in the morning because of requirements for tests in the fasting status and clinicians usually perform their testing rounds in the morning and require “fresh” laboratory results to help them determine the medical course of the patient.

The between day differences in the patient results is generally minimal. As such, the average difference of a specific laboratory result in all the patients who have their blood sampled only in the morning hours may be close to zero unless there is a persistent error in the analyzer or there is a trend in the patient data independent of the analyzer (this may be significant in only a few analytes).

Many laboratory tests are repeated (e.g., hourly, every day, or other time frame between tests). Patients who have repeat testing at most every day (e.g., somewhere between sixteen and thirty-two hours between analyte collection) are probably quite stable and are not being aggressively treated. These patients and their corresponding measurements can provide a basis for analyzing whether an operating laboratory analyzer needs recalibration or needs to be further investigated, repaired, and/or recalibrated.

Based on the high prevalence of about 24 hour repeats (about 70% of tests area repeated within forty-eight hours) and lower biologic variation at about 24 hours, patients retested at about 24 hours can be their own controls. A delta can be calculated (patient 1 (0 hours)−patient 1 (16 to 32 hours later)) for each data pair. The Standard Deviation of Duplicates (SDD) and/or average of deltas (AoD) can be calculated to determine systematic error in a laboratory analyzer and/or increased random error in the laboratory analyzer.

An AoD (e.g., a moving AoD) can be calculated, such as can include differences in an analyte measurement of a patient that is repeated within 16 and 32 hours. The AoD calculation is summarized as in Equation 1:

$$AoD = {\sum }_{i = 1}^{N} {Δ}_{i} / N . \qquad Equation 1$$

In Equation 1, Δᵢ is the difference between consecutive analyte measurements of the same patient that is repeated within 16 to 32 hours and N is the number of deltas used in determining the average. If the AoD value is outside a range of acceptable AoD values, such as a standard deviation of AoD values being outside an acceptable range of standard deviation values, then an error condition can be signaled.

The deltas can be averaged, such as by using moving averages (i.e. AoDs), with an AoD or a standard deviation of AoDs exceeding a threshold indicating a significant analytical shift. A significant analytical shift can mean that the laboratory analyzer requires servicing, such as usually includes recalibration. As analytical shifts can either represent a bad shift (going from a correct to an incorrect calibration state) or a good shift (going from an incorrect to a correct calibration state), a previous average, such as a prior day's average (mean, median, AoD, or mode), can be compared to the calculated average to determine if the shift is a good shift or a bad shift. A “normal” previous average with a higher positive or negative AoD can signal a developing error. A high previous average and a lower current average of deltas can indicate a situation in which the error condition is being corrected.

The standard deviation of the AoD (SDD) can be calculated as in Equation 2

$$\sqrt{( {{\sum }_{j = 1}}^{M}} {( Ao {D}_{j} - A o {D}_{μ} )}^{2} / M ) \qquad Equation 2$$

In Equation 2, AoDⱼ is a determined AoD value, such as by using Equation 1, AoD_{μ} is the average of the M AOD values, and M is the number of AoD values used in the standard deviation calculation.

A specified number of delta calculations (e.g., AoDs) can be used for each calculation, such as to help ensure statistical significance. The specified group size can vary between analytes. If the AD calculation is out of range, such as can be indicated by the SDD exceeding a specified SDD limit, then an error flag can be turned on.

Using software modeling of patient data collected during 669 days and selecting only those samples from patients that were repeated within 16-32 hours of the previous analysis the ability of the calculation to detect a simulated significant shift in instrument performance was demonstrated.

Each analyte to be considered for monitoring by the average of deltas (AoD) can have a unique requirement for the number of pairs (deltas) of samples to be averaged (N). Similarly, each analyte can have unique limits to the magnitude of deltas or individual analyte measurements that can be included in the calculation. In order to determine a set (e.g., an optimal set) of parameters for the AoD calculation for each analyte, the patient data pairs were analyzed via a computer script that induces a user defined error at increasing intervals throughout the data stream and calculates the average number of deltas to detection (ANDD), the standard deviation of the ANDD, mode number of deltas to detection (Mode NDD) and median number of deltas to detection (Median NDD). The computer script, using a simulated annealing algorithm stochastically selects the number of patient pairs to average (N) and the allowable magnitude of the delta pairs, or truncation limits, to use to minimize the ANDD value.

The truncation limits in effect exclude delta values greater than or less than a set limit from the ANDD calculation. Selection of the upper truncation limits (TLU) or lower (TLL) is intended to reduce the magnitude of the ANDD oscillations caused by large deltas. The exclusion of the larger deltas can serve at least two purposes. The first is that the AoD calculation relies on pairs of values from stable patients to determine the analytic performance of the instrument; pairs of samples with large deltas likely do not represent stable patients. The second purpose is strictly mathematical, large values when included in an average calculation will unduly pull the mean towards an extreme value. In general, the size of the allowable delta (e.g., an allowable measurement value) is a function of the difference between the concentrations of the analyte of interest between healthy and acutely ill patients, the maximal physiologically delta possible within 16-32 hours, and the magnitude of the analytical error or bias one is trying to detect.

As an example of this effect, simulations determined the truncation limits for pairs of potassium results to be 1.20 and −1.59 mmol/L to detect a shift of +/−0.5 mmol/L. In contrast, for Alanine Aminotransferase, simulations determined truncation limits were to be 31 and −16 U/L to detect a shift of +/−7 U/L.

Using this system, the N value and truncation limits for each analyte to be monitored could be determined from a stream of historical data pairs. If the AoD shifts due to an out of control instrument condition, the AoD will exceed the user defined limit and the system or device will laboratory personnel to the error condition.

The AoD was developed to improve SE detection in commonly repeated analytes for hospital patients. As discussed, in AoD, the average difference between pairs of consecutive intra-patient results acts as a surrogate assessment of analytic variation. This QC approach is deemed to be optimal in acute care laboratories that rapidly provide blood test results on a 24 hour a day, seven days a week basis. The current AoD approach uses patient test results that are obtained on consecutive days. Patients who are receiving blood testing on a daily basis are generally more ill and might in fact require hospital care. Sadly, as the prevalence of overtesting and overdiagnosis relentlessly expands, more money will be spent on more frequent but medically unnecessary testing. Minimally, the mix of these unnecessary test results and medically indicated tests can be transformed into actionable indicators of laboratory quality.

Referral or outpatient laboratories are often located significant distances from hospitals. These laboratories generally analyze blood specimens of healthier, ambulatory outpatients. A relatively small number of these patients receive daily, repeated testing. Repeated testing in outpatients is often scheduled weekly, monthly, quarterly, semiannually, and annually.

The discussion thus far provides a simplified view of error. Every laboratory result is a product of an analysis containing variable amounts of analytical error. Simplistically, analytical error is considered to have two components, a systematic error component resulting in a deviation of the mean from the usually stable mean over one or more analytical runs. Increased random error is the second component and results in a variably increased dispersion of results about the mean over one or more analytical runs. QC samples are analyzed regularly over the course of the workday to detect significant (statistically and clinically more than the usual) error. Error detection should be followed by appropriate investigation and error correction.

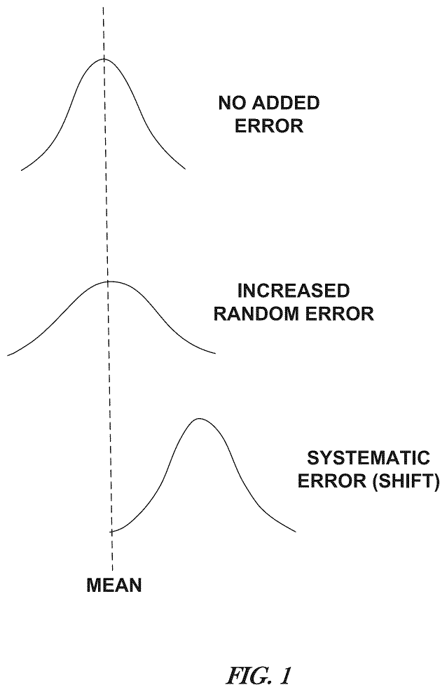

FIG. 1 illustrates, by way of example, simple graphs that help explain different types of errors. The top most graph shows a typical bell curve of samples. The middle graph shows a bell curve with increased random error relative to the top most graph. In the middle graph, the peak is less defined (there are fewer samples at the mean) but the mean remains the same as if there is no added error. The bottom graph shows a bell curve with SE. The SE is seen by shifting the bell curve off the mean, without altering the shape of the bell curve relative to the top most graph. Most the time, there is increased random error and SE, and it is difficult to discern between them.

FIG. 1 illustrates the effect of added error (random or systematic) on the distribution of QC specimens. The QC specimens being surrogates of highly stable patient specimens. The model of FIG. 1 is overly simplistic and does not incorporate. 1) the reporting of consecutive intra-patient laboratory results by two or more analyzers, 2) intermittent dispersions or intermittent mean changes and 3) simultaneous occurrences of increased dispersion and changes in the mean. The clinical chemist assumes that if today's assay passes QC, the patient results are fit for release. In most cases, this assumption is valid, especially if the physician assessment of the patient's test results involves the comparison of the current result to a broad patient reference interval. However, the assumption is not always valid as many tests are ordered to determine improvements or deterioration in clinical status or to make a diagnosis based on the change in the measured substance.

For predictable error analysis, the SE component should yield a deviation of the mean that is close to 0 and the random error component should produce results with low dispersion and a fairly constant imprecision (generally determined with the standard deviation calculation). One or more prior patent application by Cembrowski et al. uses the Average of Patient Deltas (1) to detect shifts or added systematic error. A 24 hour delta can be used for patients receiving around the clock care and more complex deltas can be applied to patients receiving repeated, longer-term testing with the tests timed to mitigate the confounding effect of diurnal variation.

FIG. 1 illustrates the effect of added error (random or systematic) on the distribution of QC specimens, surrogates of highly stable patient specimens. This model is overly simplistic and does not incorporate: 1) the reporting of consecutive intrapatient laboratory results by two or more analyzers, 2) intermittent dispersions or intermittent mean changes and 3) simultaneous occurrences of increased dispersion and changes in the mean. The clinical chemist assumes that if today's assay passes QC, the patient results are fit for release. In most cases, this assumption is valid, especially if the physician assessment of the patient's test results involves the comparison of the current result to a broad patient reference interval. That is not always the case as many tests are ordered to determine improvements or deterioration in clinical status or to make a diagnosis based on the change in the measured substance.

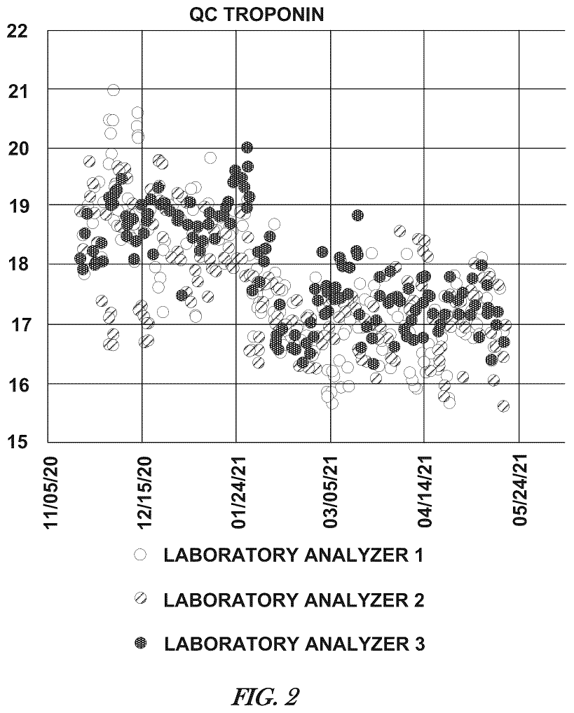

FIG. 2 illustrates, by way of example, a diagram of a graph of troponin QC results from three different laboratory analyzers. The troponin QC chart in FIG. 2, indicates a potentially uncomfortable situation where multiple analyzers in the same laboratory can produce clinically different troponin trends. In the example of FIG. 2, results depend on which of three laboratory analyzers are used to measure a patient's first, second and successive troponin samples. Towards the beginning of the data collection period the second laboratory analyzer is producing lower value troponins. If a patient were admitted with chest pain and had troponins ordered on the second laboratory analyzer and then on the first laboratory analyzer, there would be an indication of an increase in troponin which is associated with the diagnosis of an ischemic myocardium. If the patient just had serial tests from the third laboratory analyzer, there might be no significant changes in the patient's troponin thus yielding another diagnosis, that of chest pain with no increase of troponin.

These QC results, when viewed dispassionately are very concerning (e.g., when measurements are made at critically low concentrations and the physician or machine learning (ML) application is comparing the current analyte level to the prior results, or prostate specific antigen (PSA) in someone with presumptive removal of all his prostate tissue, or high sensitivity troponin or even TSH in a patient treated with thyroxine to suppress her/his thyroid function). In the foreseeable future, any ML evaluation of solely laboratory QC data might not be endorsed by either the laboratorian or the regulatory community due to multiple factors including assay traceability, the matrix of the QC specimen, and the requirement for rigorous correlation with the simultaneous assay of the patient specimens that may or may not be affected in the same manner as the QC samples.

Embodiments of this disclosure provide a patient-centered QC analysis in which new sequential patient test results are immediately compared to diurnally matched prior test results from the same patient in small groups of patient pairs that have been accumulated for that analyte and class of analyzer (hospital laboratory, critical care, referral laboratory). Assessments of the random error in the series of paired results allows the detection of apparent random error signals which will initiate the immediate assessment of contemporaneous reference sample QC data available for the same instrument(s) used to test the specimens signalling the increased random error. If there is concordance of the QC data and the patient random error signals, the laboratory will follow an error investigation and mitigation procedure. If the QC data do not provide a random error signal, the batch of apparently errant specimens should be analyzed on an alternate analyzer and reported. If no other analyzer is available, the instrument should be recalibrated and the specimens reanalyzed.

Demonstration of within Patient Test Stability of Samples Collected at the Same Time of Day.

The inventors have discovered that if a patient has analyte specimen collections separated by 24 hours or 7, 14, 21 or 28 days and the specimen is collected within the same hour and within 2 hr of the original blood draw, the similarity of the results are close to those derived from normal subjects who have weekly, regular morning testing. Obtaining the specimen collection at the same time of day reduces the influence of diurnal variation. Repeated testing in patients (usually outpatients) is often scheduled weekly, monthly, quarterly, semiannually, and annually.

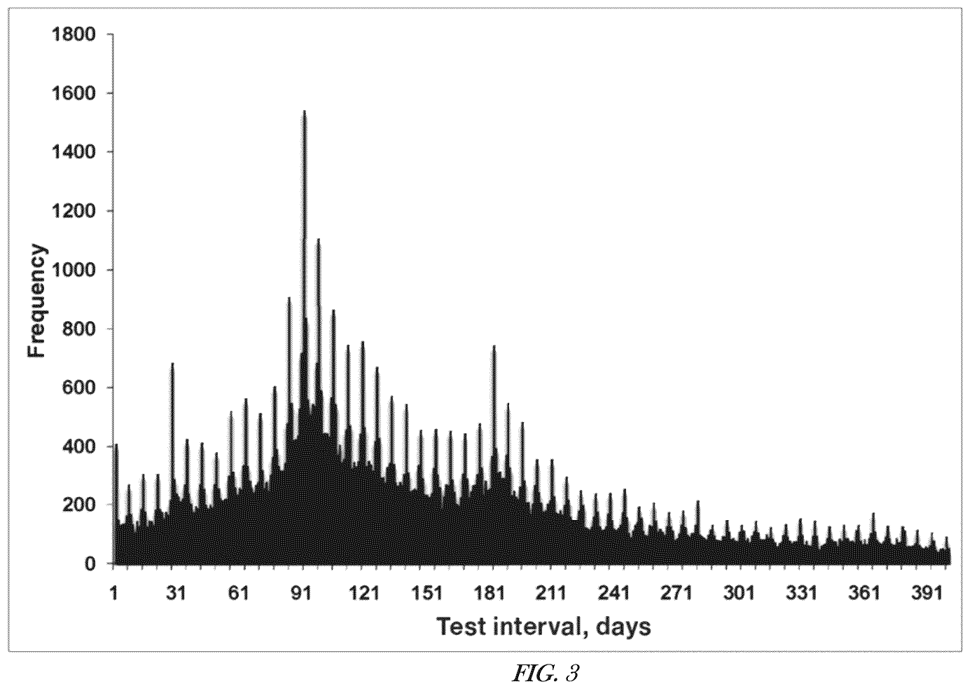

FIG. 3 illustrates, by way of example, a graph of a test-ordering pattern of hemoglobin A1c (HbA1c), used to monitor diabetes control, generally in outpatients. While plotting the daily frequency distribution of HbA1c testing, the author noted “this complex distribution for a single (geographical region) shows a spike-like surge at 7-day intervals superimposed on multiple modes at day 31, 91, and 183. The spike-like surge is attributed to the tendency of patients to have phlebotomy on the same days of the week (Monday-Monday, Saturday-Saturday).” There is often large spike in the first day (day 0) of FIG. 3 that is attributed to the magnitude of HbA1c results that were unexpected by the ordering clinician who then ordered confirmatory testing. The number of tests repeated on day 0 exceeds those repeated 7, 14 and 21 days later (but not those repeated 28 days later). FIG. 3 shows a frequency distribution of HbA1c test intervals in the Edmonton region and is from from Lyon A W, Higgins T, Wesenberg J C, Tran D V, Cembrowski G S. Variation in the frequency of hemoglobin A1c (HbA1c) testing: population studies used to assess compliance with clinical practice guidelines and use of HbA1c to screen for diabetes. J Diabetes Sci Technol. 2009; 3:411-7.

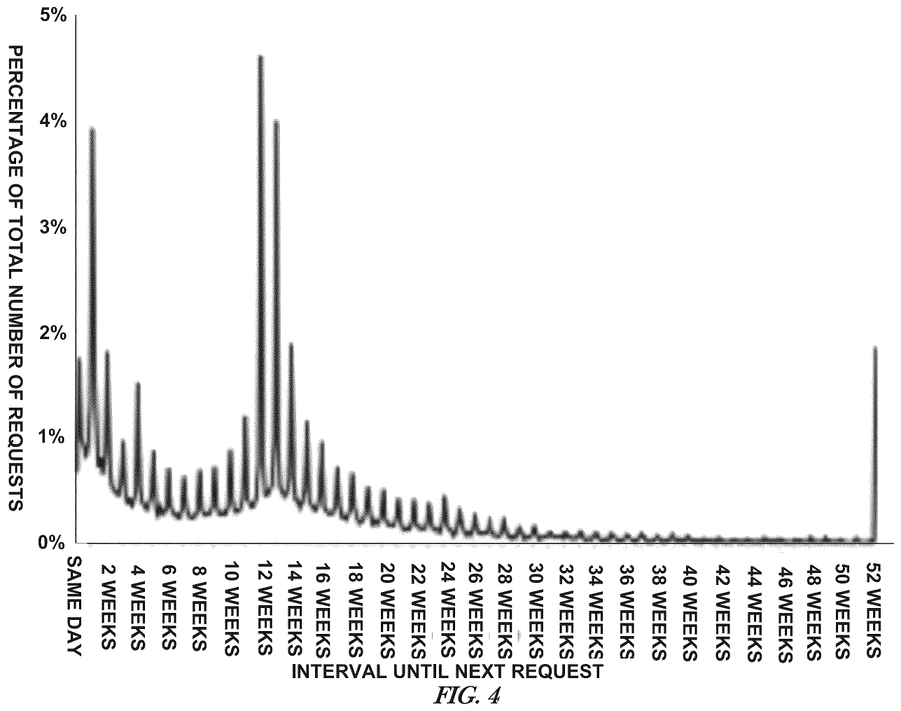

FIG. 4 illustrates, by way of example, a graph of frequency of intervals between consecutive lithium requests. The graph in FIG. 4 is similar to that of FIG. 3. The graph of FIG. 4 is from Parfitt C, Duff C J, Scargill J, Green L, Holland D, Heald A H, and Fryer A A in “Serum lithium test requesting across three UK regions: an evaluation of adherence to monitoring guidelines”. BMC psychiatry. 2021 December; 21(1): 1-0. (3). FIG. 4 shows all the lithium tests ordered in three United Kingdom regions over one year. Lithium level testing is usually an outpatient test (lithium is used to treat affective disorders). The peaks in the graph of FIG. 4 are similar to the A1c peaks documented by Lyon in FIG. 3. The authors' Week 1 has been cut into an early and late peak. The early peak consists of tests re-ordered within 0 to 1 days of the first test, probably to confirm an unexpected value, either a very low level or a level that is too high.

Table 1, below shows intervals between lithium requests stratified by initial lithium concentrations. Table 1 shows that the most frequent initial test levels that are repeated within the first day (day 0) and are represent very low or high and potentially toxic lithium levels. The second peak of the first week occurs around 7 days and has an amplitude close to those of the 12 and 13 week (three month) lithium peaks. The Table indicates that many of the original tests that were repeated early (but probably not as late as 7 days) indicated very low or or potentially toxic levels, consistent with physician surprise with the laboratory results and a rapid re-ordering of a confirmatory lithium level.

TABLE 1
Intervals between lithium requests stratified by initial
lithium concentrations, from Parfitt C, Duff C J, Scargill
J, Green L, Holland D, Heald A H, Fryer A A. Serum lithium
test requesting across three UK regions: an evaluation
of adherence to monitoring guidelines. BMC psychiatry.
2021 December; 21(1): 1-0 . . . ”, preprint

| | | 0.1- | 0.4- | 0.6- | 0.8- | 1.0- | |
|---|---|---|---|---|---|---|---|
| Interval | <0.1 | 0.39 | 0.59 | 0.79 | 0.99 | 1.39 | >1.4 |
| (days) | (%) | (%) | (%) | (%) | (%) | (%) | (%) |
| 0-1 | 2.6 | 2.2 | 1 | 1 | 1.6 | 9.8 | 60.5 |
| 2-7 | 14.1 | 16.2 | 6.5 | 4.3 | 7.4 | 25.6 | 26.6 |
| 8-76 | 45.6 | 46.4 | | 27.8 | 33 | 46 | 9.9 |
| 77-98 | 7.6 | 13.1 | 24.53 | 27 | 23 | 6.1 | 0.2 |
| 99-160 | 11.7 | 12.6 | 22.0 | 23.7 | 21.1 | 7.3 | 1.3 |
| 161-189 | 3.4 | 2.7 | 5.2 | 5.9 | 4.9 | 1.5 | 0.4 |
| 190-365 | 8.8 | 5.0 | 8.5 | 8.6 | 7.5 | 2.9 | 0.6 |
| >365 | 6.1 | 1.7 | 2.0 | 1.8 | 1.5 | 0.8 | 0.4 |
| Total | 100 | 100% | 100% | 100% | 100% | 100% | 100% |

In a preliminary analysis of 5 years of patient data from Ottawa Hospital, one or more of the inventors extracted patients who were identified as outpatients and created graphs of a number of outpatients who had tests repeated within 96 successive weekly periods, ranging from being repeated up to 1 week later, between 1 and 2 weeks later, . . . up to between 96 and 97 weeks later.

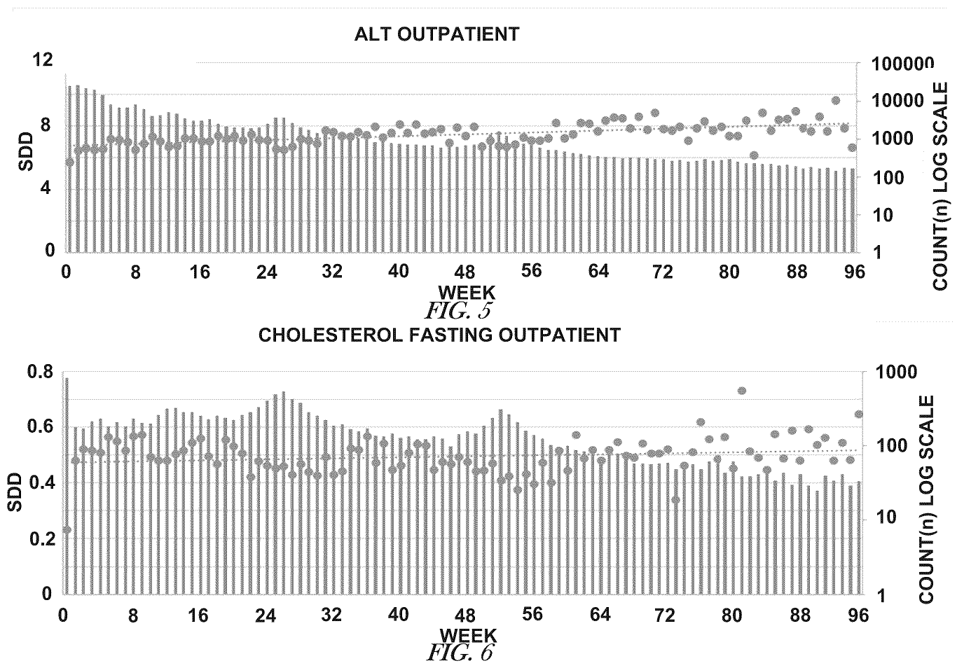

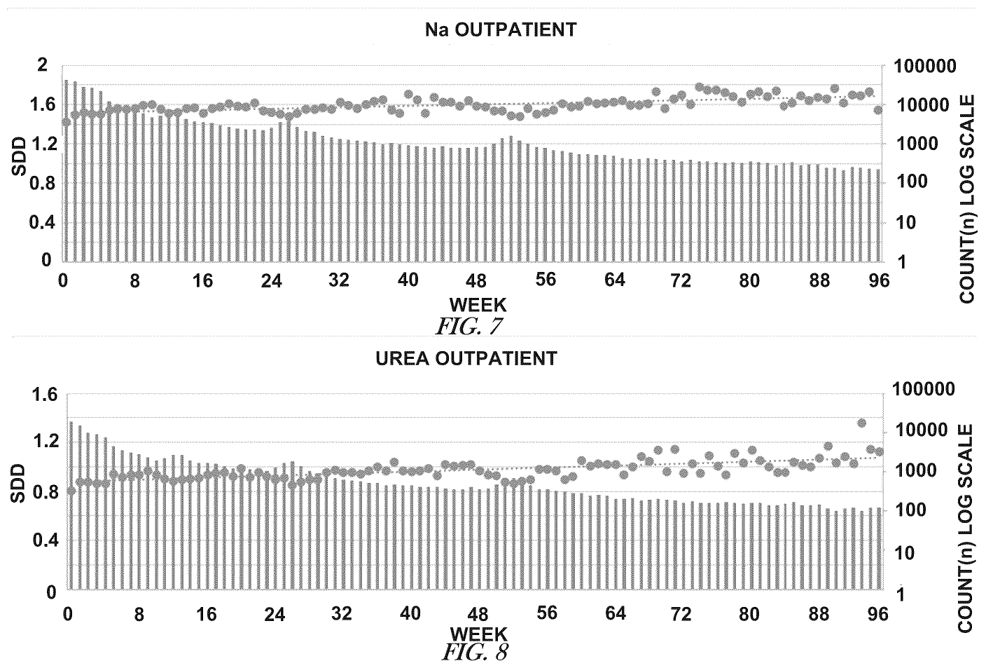

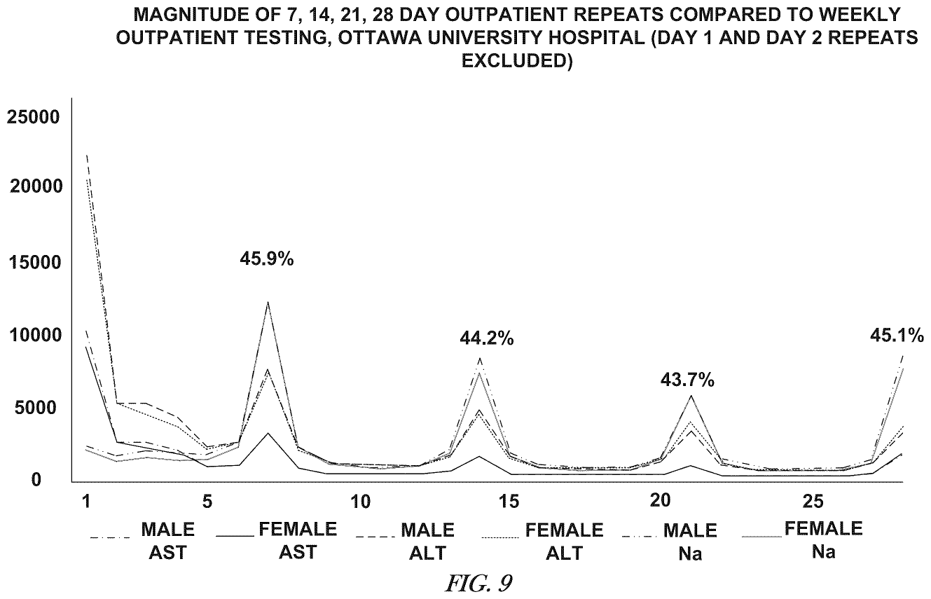

FIGS. 5-8 illustrate, by way of example, respective graphs of the results of analyzing five years of patient data. In FIGS. 5-8, the vertical bars correspond to the number of patients whose tests are repeated within each of those weekly periods. The circles indicate the variation between the initial measurements before week 0 and the paired measurement of the week in question (standard deviation of differences calculated from the paired patient laboratory values). FIG. 5 illustrates, by way of example, a graph of ALT outpatient repeats and standard deviation of deltas (SDD) versus number of weeks between tests. FIG. 6 illustrates, by way of example, a graph of cholesterol fasting outpatient repeats and standard deviation of deltas (SDD) versus number of weeks between tests. FIG. 7 illustrates, by way of example, a graph of sodium (Na) outpatient repeats and standard deviation of deltas (SDD) (sometimes called standard deviation of differences) versus number of weeks between tests. FIG. 8 illustrates, by way of example, a graph of urea outpatient repeats and standard deviation of deltas (SDD) versus number of weeks between tests. With the exception of the ALT test, the number of patients reanalyzed in the first week exceeded the patient repeats for all of the other 95 weeks.

For patient-based QC to be effective, the signal of an unacceptably large shift must be large enough to result in unacceptable error and detected as early as possible. For detecting shifts with AoD, the signal strength depends on the size of the shift, the number of available between day differences that can be averaged and the stability of the differences arising in the absence of important analytical errors. For many tests measured in the referral/outpatient laboratory, the number of between day differences appears to be maximal at 7 day intervals.

To maximize the number of patient pairs used to calculate the AoD, especially in the outpatient (and thus the referral or outpatient laboratory) it is recommended to calculate between week (7 day) intrapatient deltas for analytes that are frequently repeated and are within the +/−2 hr window of modulus 24 of the difference in hours between the paired specimens (e.g., the same 2 or 4 hour window). The Appendix shows the consistently low SDD in paired tests that are done weekly at about the same time of day (within 2 hours or 4 hours). Besides maximizing the number of test duplicates, the use of 7 day differences provides appropriate comparisons between within either the weekday operation and within the weekend operation. The weekday and weekend operations can differ significantly based on the patient morbidity (higher on weekends), the number of instruments in use (less on weekend), and even the type of operating instruments, operators, etc. While these tests are tests done by instruments classified as chemistry tests, the same weekly AoD or between day AoD QC can be executed on all laboratory instruments including those that perform hematology tests.

If there are insufficient 7 day pairs to calculate an accurate AoD, the range of for collecting patient differences can be extended to 7 and 14 days or even 7 and 14 and 21 days or 7 and 14 and 21 and 28 days. All between nonconsecutive day samples must be obtained within the +/−2 hr window of modulus 24 of the difference in hours between the paired specimens.

FIG. 9 illustrates, by way of example, a graph of a frequency histogram of daily number of AST, ALT, and Na repeated tests after an initial test. As can be seen, the relative number of patients who tests are repeated at 7, 14, 21 or 28 days is large. At Ottawa Hospital, of the for AST, ALT and Na tests that are repeated within 7 or 14 or 21 or 28 days, between 44% and 46% are repeated 7, 14, 21 or 28 days later, respectively.

For smaller referral laboratories, the daily number of diurnally matched patient pairs depends on the type of test and fluctuate depending on the day of the week and the day of the month correlating with patient visits and testing schedules.

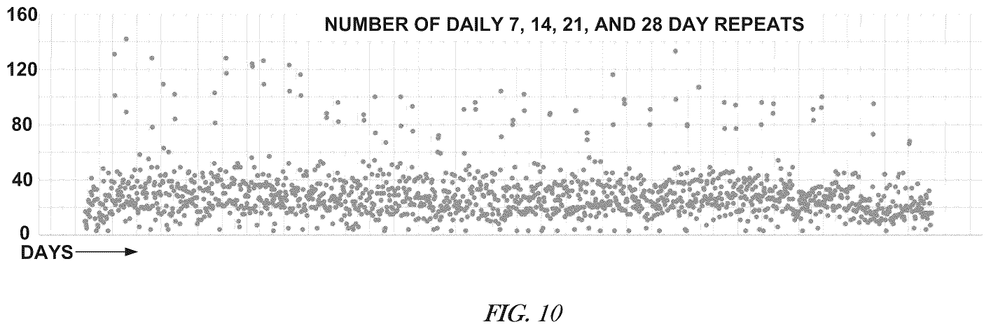

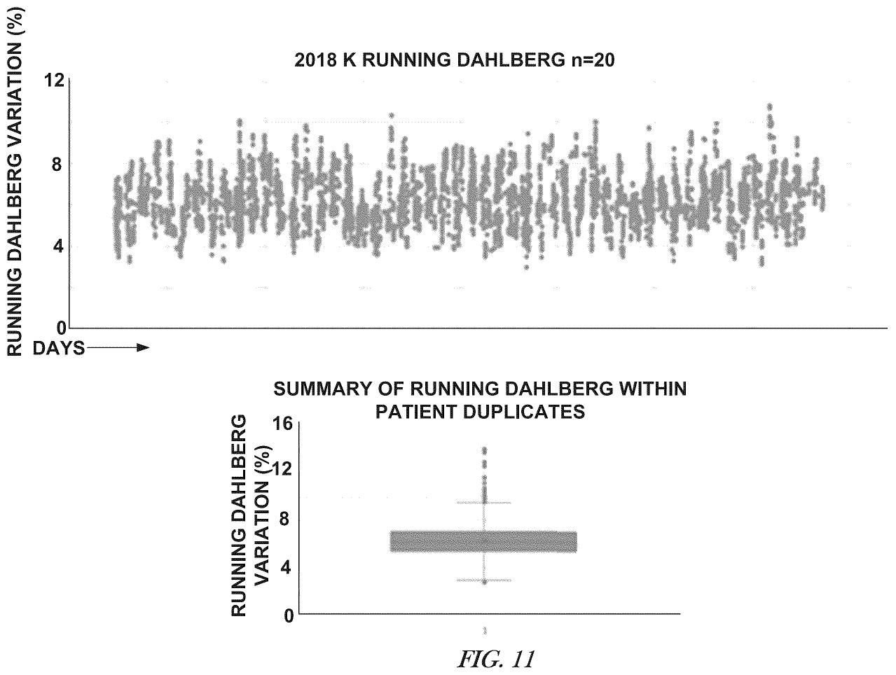

FIG. 10 illustrates, by way of example, a graph of a number of patient pairs per day for potassium over the entire five years of data. There are very few pairs on weekends and there are two modes, the lower ranging from 25 to 30 pairs and the higher from around 80 to 100 pairs.

### Calculation of Random Variation of Diurnally Matched Patient Pair Sets

The most used measure, and probably the easiest applied measure of laboratory variation of paired data, is Dahlberg's calculation. The interaction of biologic, analytical and preanalytical variation can be analyzed using a standard Dahlberg Equation (Equation 1):

$$s = \sqrt{{\sum }_{i = 1}^{N} {( {x}_{i , 1} - {x}_{i , 2} )}^{2} / 2 N} = \sqrt{{\sum }_{i = 1}^{N} {d}_{i}^{2} / 2 N}$$

Equation 1 generates a standard deviation term. To make the standard deviation term a relative error, the standard deviation term can be divided by the grand mean of the observations. There is another Dahlberg variation that generates a relative random error, obviating the need to calculate the mean (Equation 2):

$${s}_{rel} = \sqrt{{\sum }_{i = 1}^{N} 2 {( ( {x}_{1} - {x}_{2} ) / ( {x}_{1} + {x}_{2} ) )}^{2} / 2 N}$$

A third Dahlberg variation is termed the expanded Dahlberg and can accommodate a bias (systematic differences between the first and second set of observations) (Equation 3):

$${s}_{M} = \sqrt{{\sum }_{i = 1}^{N} {( {d}_{i} - \overline{d} )}^{2} / 2 ( N - 1 )}$$

Where dᵢ is the difference between the pairs of replicate measurements, N is the number of cases, d̅ is the mean of the dᵢ and s_{M} is the statistical estimate of the ‘true’ error (standard deviation).

Others have shown that irrespective of the formula used, analyzing a sample of less than 25 to 30 replicated measurements, the resulting estimates of error are potentially unreliable and may under- or over-estimate the true error. It is thus problematic that the daily number of patient pairs varies in most laboratories and may vary day to day by a factor three or more.

### Implementation of Dahlberg's Analysis of 1, 7, 14, 21, and 28 Day Patient Replicates

Each time that a patient specimen is analyzed, the laboratory information systems determines if the same patient has had a blood sample drawn at the same time of day (±2 h) 1, 7, 14, 21 or 28 days previously. If so, the prior and current results are tabulated. Table 8 is such a tabulation.

TABLE 2
Repeated potassium draws including prior value (val1), recent value
(val2), delta, time delta, value delta, value delta squared

| | | | Time | Value |
|---|---|---|---|---|
| | | Value | Delta | Delta |
| Val1 | Val2 | Delta | (mod 24) | Squared |
| 4.9 | 5.1 | 0.2 | 0 | 0.04 |
| 4.7 | 5.1 | 0.4 | 0 | 0.16 |
| 3.7 | 3.8 | 0.1 | 0 | 0.01 |
| 4 | 4 | 0 | 1 | 0 |
| 4.4 | 3.8 | −0.6 | 0 | 0.36 |
| 4 | 4.4 | 0.4 | 1 | 0.16 |
| 4 | 4 | 0 | 0 | 0 |
| 4.7 | 4.2 | −0.5 | 2 | 0.25 |
| 4.2 | 4.2 | 0 | 1 | 0 |
| 4.6 | 4.1 | −0.5 | 1 | 0.25 |
| 4.1 | 3.9 | −0.2 | 0 | 0.04 |
| 4.1 | 4.1 | 0 | 2 | 0 |
| 4.3 | 3.8 | −0.5 | 0 | 0.25 |
| 4.5 | 4.1 | −0.4 | 0 | 0.16 |
| 4.1 | 3.3 | −0.8 | 0 | 0.64 |
| 3.4 | 3.3 | −0.1 | 1 | 0.01 |
| 4 | 4.3 | 0.3 | 0 | 0.09 |
| 3.9 | 4.2 | 0.3 | 1 | 0.09 |
| 4 | 4.4 | 0.4 | 0 | 0.16 |
| 3.8 | 3.8 | 0 | 0 | 0 |
| 3.4 | 3.4 | 0 | 1 | 0 |
| 4.4 | 4.1 | −0.3 | 0 | 0.09 |
| 3.6 | 3.4 | −0.2 | 1 | 0.04 |
| 4.2 | 4.3 | 0.1 | 1 | 0.01 |
| 3.9 | 3.5 | −0.4 | 0 | 0.16 |
| 4.2 | 4 | −0.2 | 0 | 0.04 |
| 3.6 | 3.4 | −0.2 | 0 | 0.04 |
| 4.2 | 4.5 | 0.3 | 1 | 0.09 |
| 4.3 | 4.4 | 0.1 | 1 | 0.01 |
| 4.4 | 4.2 | −0.2 | 0 | 0.04 |
| 4.7 | 4.4 | −0.3 | 0 | 0.09 |
| 4.8 | 4.6 | −0.2 | 1 | 0.04 |

Analyses using Equations 1, 2, and 3 on all entries in Table that had the relevant prior results were performed. The results of the Equations were determined on a daily basis and results of all three Equations were incorporated with all of the current and prior patients' potassiums.

FIG. 10 illustrates, by way of example, graphs of a running Dahlberg analysis using Equation 1 generating a continuous running average of the last 20 random variation estimates. The Dahlberg's assessments of the random error in the series of paired results allows the detection of apparent random error signals regardless of which Equations 1-3 is used to determine the random error. These random error signals must be assessed in terms of the nature of the error detected: random or random plus systematic. The detected error can then be correlated with the contemporaneous QC data. If a significant number of the high Dahlberg variations exist and correlate with the QC findings, there is an issue with the laboratory analyzer. This mode of QC can be introduced into the toolbox of quality laboratory practices. It is sufficient for a significant proportion of the signals to correlate with the QC data, viz around 20 to 30%. QC is run infrequently and may not be sufficient to detect the errant runs.

After the error range for the Dahlberg's values is defined for each analyte and level, the outlying Dahlberg calculation can initiate an immediate assessment of all contemporaneous reference sample QC data available for the same instrument(s) used to test the specimens signalling the increased random error. Initially, this quality practice can be used for some of previous described analytes: troponin, hCG, TSH. If there is concordance of the QC data and the patient random error signals, the laboratory can follow an error investigation and mitigation procedure. If the QC data do not provide a random error signal, the batch of apparently errant specimens should be analyzed on an alternate analyzer and reported. If no other analyzer is available, the instrument should be recalibrated and the specimens reanalyzed.

Timing of test orders to reduce the confounding effects of diurnal and seasonal variation and to optimize the recognition of real and significant laboratory changes. There is sufficient similarity in the paired intra-subject laboratory measurements that are drawn at the same time of day within a +/−2 hr interval to reduce or remove biologic variation. This similarity allows physicians and ML programs to define probable changes in the laboratory measurements, initiate investigations, and diagnose improvements or deteriorations in the patient condition. If the test pairs are drawn within a month of each other, the 7, 14, 21 and 28 day pairs are remarkably similar in terms of biologic variation. As the time interval between consecutive laboratory paired tests widens to 3 to 9 months, the differences between the test pairs will tend to increase (or decrease). A minority of these changes are due to culture and ethnic traditions. Most of these non-diurnal, within year, increments or decrements in the between pair differences will be observed in non-equatorial regions and are associated with our human physiology being influenced by the season.

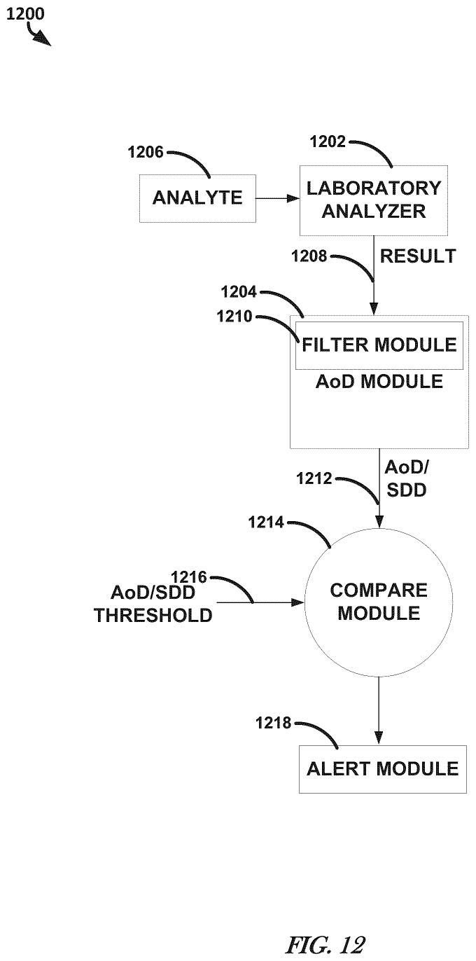

FIG. 12 illustrates, by way of example, a block diagram of an embodiment of a system 1200 to determine if a laboratory analyzer requires just recalibration or a more complete investigation, which usually includes recalibration. The system 1200 as illustrated includes a laboratory analyzer 1202 and an AoD module 1204. The laboratory analyzer 1202 can include a hematology, chemistry, or other analyte analyzer. The laboratory analyzer 1202 can take an analyte 1206 as an input and produce a result 1208 that is a measurement of a property (e.g., height, width, volume, area, concentration, pH, or the like) of the analyte 1206. The result 1208 can be provided to the AD module 1204. The result 1208 can include a tag that indicates the patient identity that the result 1208 is associated with. The result can include a tag that indicates a time the analyte 1206 was obtained from the patient. The tag information can be gathered manually, such as by a nurse, and input to the system 200, such as through a User Interface (UI) not shown in FIG. 12, or automatically entered, such as by a “smart” laboratory analyzer.

The AoD module 1204 can determine an AoD or SDD of the results 1208. The AoD module 1204 can include a filter 1210. The filter 1210 can implement a value delta filter and/or a time delta filter that filters based on consecutive analyte results from the same patient. The filter 1210 can compare the value deltas to a specified value delta threshold. The value delta threshold can be set by an expert or other personnel and can be set based on the analyte and the amount of error that is considered acceptable in the result without giving a false positive on determining that the laboratory analyzer 1202 is to be calibrated. If a calculated value delta is greater than the value delta threshold, the filter 1210 can remove the value delta from the results used by the AoD module 1204 to calculate the AoD/SDD. Note that results can alternatively be filtered individually, such as to remove results above and/or below one or more specified limits. This can help ensure that the delta value calculations are within specification without needing to calculate the delta value.

Similarly, the filter 1210 can compare the time delta to a specified time delta range. The specified time delta range can indicate a time range between deltas that is acceptable. For example, the time delta range can be between a multiple of seven days and modulus 24 hours plus or minus about two hours, or the like. The closer the time delta range is to seven days and at the same time as the immediately previous test (i.e. modulus twenty-four hours), the lower a biologic variation is expected to be, thus a smaller value delta is expected. If the time delta between consecutive results for the same patient is outside of the time delta range, the filter 1210 can remove the value(s) or the delta corresponding to the value(s) from the results to be used by the AoD module 104 to calculate the AoD.

Note that biologic variation is also seasonal. So if the time delta range is greater than 28 days, the biologic variation between samples tends to be greater. Thus, a time difference between samples around the same date each year and at about the same time of day tend to have less biologic variation than samples that are between one month and 11 months apart. Thus, the filter 1210 can remove samples that are greater than 28 days different and less than 338 days different. This leaves results 1208 that are the same seasonally, taken about the same time of day, and taken on the same day of the week.

The AoD module 1204 can receive value deltas from the filter 1210 that are less than the value delta threshold and whose time tags indicate that the time delta is within the time delta range. The AoD module 1204 can determine an average (e.g., a moving average) of SDD of the value deltas from the filter 1210. The AoD 1212 can be provided to a compare module 1214. The number of AoD values used to determine an AoD value can be predetermined, such as to help guarantee statistical significance.

The compare module 1214 compares the AoD/SDD 1212 to one or more AoD/SDD thresholds 1216. The AoD threshold 1216 defines acceptable AoD/SDD values. If the compare module 1214 determines that the AoD/SDD 1212 is not within the range of acceptable values, an indicator signal can be provided to an alert module 1218. Additionally or alternatively, the compare module 1214 can compare the AoD/SDD 1212 to other AoDs/SDDs, such as one or more of the most recent AoDs/SDDs (a prior AoD/SDD, such as one or more immediately previous AoDs/SDDs), to determine if there is a trend in the AoDs/SDDs received. For example, the compare module 1214 can determine that the most recent AoDs indicate that the AoDs are trending (increasing or decreasing) and that the laboratory analyzer 1202 is to be calibrated or otherwise examined by the proper personnel. The compare module 1214 can provide an indicator to the alert module 1218 that causes the alert module 1218 to transmit a message to the proper personnel.

The alert module 1218 can provide a message to proper personnel indicating that the laboratory analyzer 1202 is to be calibrated, such as by a lab technician, a laboratory analyzer manufacturer, personnel that can calibrate the laboratory analyzer 1202, or other personnel. The message can include a text message, a phone call, such as an automated phone call with one or more standard messages, an email, a communication using a software chat program, an audible alarm, or other message. If recalibration is not successful in bringing the operation of the laboratory analyzer within tolerance levels then the operation of the laboratory analyzer should be investigated more thoroughly.

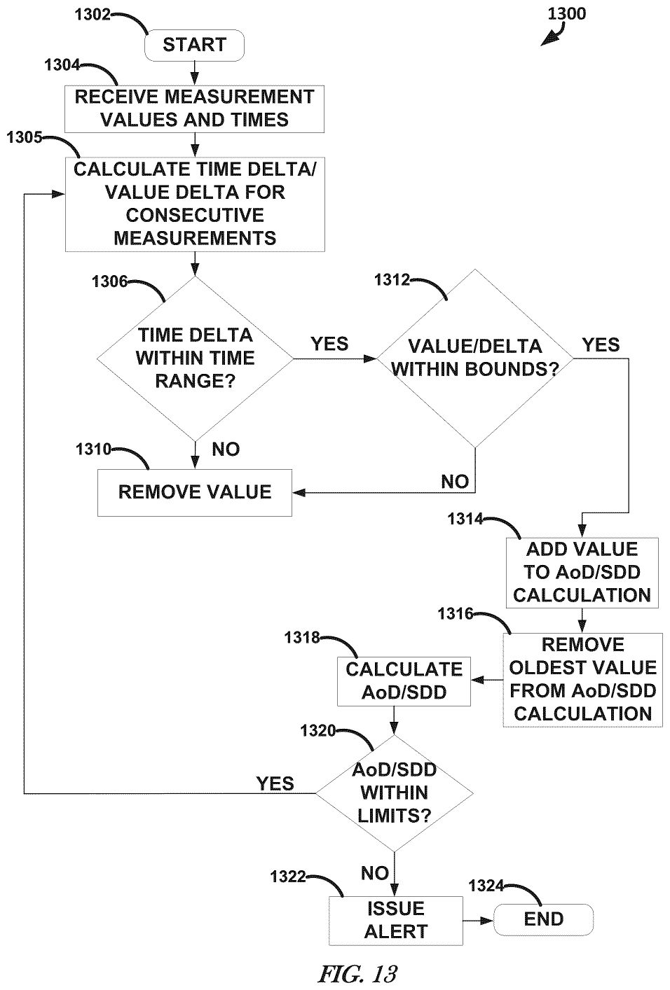

FIG. 13 illustrates, by way of example, a flow diagram of an embodiment of a method 1300 of determining if a laboratory analyzer is to be calibrated. The method 1300 can be implemented using the system 1200, for example. The method 1300 as illustrated includes beginning at operation 1302. At operation 1304 measurement values and corresponding times can be received. The measurement values can include a time tag and/or a patient tag associated therewith. A time delta can be calculated for consecutive measurements of the same patient at operation 1305.

At operation 1306, it can be determined whether the time delta is within a specified time delta range. If the time delta is not within the time delta range then the measurement value can be removed at operation 1310 and another time delta can be determined at operation 1305. If the time delta is within the time delta range it can be determined if the measurement value (e.g., an individual value or a delta value) is within one or more specified measurement bounds at operation 1312. If the value is not within the specified bounds, the measurement value can be removed at operation 1310 and another time delta can be determined at operation 1305. If the value delta is less than the value delta threshold, the value delta can be added to an AoD/SDD calculation at operation 1314. At optional operation 1316 a current oldest value (e.g., delta value) being used to calculate the AoD/SDD can be removed. Such a configuration provides a first in first out (FIFO) sort of calculation for the AoD/SDD. An alternative to the FIFO style calculation include waiting until a specified number of new values are received to calculate the AoD/SDD and waiting a specified amount of time before calculating the AoD/SDD, among other alternatives.

At operation 1318 the AoD/SDD and/or one of Equations 1-3 can be calculated using the determined and approved value. At operation 1320 it can be determined whether the AoD/SDD and/or one of Equations 1-3 is within specified limits. If the AoD/SDD and/or one of Equations 1-3 is within the specified limits, the method 1300 can resume at operation 1305. If the AoD/SDD and/or one of Equations 1-3 is not within the limits, an alert can be issued at operation 1322. An alternative to determining if the AoD/SDD and/or one of Equations 1-3 is less than the threshold at operation 1320 includes determining if the AoD/SDD and/or one of Equations 1-3 is trending either upward or downward so as to warrant issuing an alert at operation 1322. In one or more embodiments, an alert may be sent only if consecutive AoD/SDD and/or one of Equations 1-3 measurements (e.g., two, three, four, five, six, etc.) are outside the limits and/or if consecutive AoD/SDD and/or one of Equations 1-3 measurements that pass the filter are trending in the same direction. The method 1300 can end at operation 1324.

TABLE 3
Example time deltas and value deltas for each patient

| | | VALUE | | VALUE | | VALUE |
|---|---|---|---|---|---|---|
| PA- | TIME | DELTA | TIME | DELTA | TIME | DELTA |
| TIENT | DELTA 1 | 1 | DELTA 2 | 2 | DELTA 3 | 3 |
| A | 7 d 2 h | −0.49 | 7 d 10 h | 0.64 | 7 d 0 h | −0.2 |
| B | 13 d 23 h | 0.14 | 14 d 2 h | 0.22 | 15 d 1 h | −0.15 |
| C | 7 d 0 h | −0.09 | 7 d 1 h | 0.28 | 7 d 4 h | −0.4 |
| D | 11 d 18 h | −0.04 | 9 d 2 h | 0.27 | 8 d 9 h | −0.22 |
| E | 13 d 9 h | 0.1 | 14 d 19 h | −0.22 | 15 d 20 h | 0.16 |
| F | 21 d 0 h | 0.16 | 21 d 2 h | −0.4 | 21 d 1 h | 0.16 |
| G | 28 d 1 h | 0.38 | 363 d 22 h | −0.18 | 371 d 2 h | 0.2 |

Table 3 includes a variety of patients A, B, C, D, E, F, and G and three consecutive analyte delta measurement and time delta measurements.

For explanation purposes, assume that a time delta range is set to be (i) within 4 hours of the time of day and same day of week of an immediately previous analyte measurement or (ii) within 28 days and 4 hours or 337 and 393 days and within 4 hours and on the same day of week and that (a) a maximum measurement value is set to be five (5.0) and a minimum measurement value is set to be three (3.0). The time delta range and the maximum and minimum measurement value bounds define the delta values that will be used in an AoD calculation. In the example of the delta values of Table 3, value delta two for patient A, value delta 3 for patient B, and value deltas 1, 2, and 3 for patients D and E would be filtered out of the set of value deltas used in the AoD/SDD calculation. This is because the time delta does not fall in the acceptable time delta range specified. None of the measurement values are filtered out because none of the measurement values are greater than five or less than three in this example. Note that instead of defining upper and lower bounds on individual measurement values, a maximum delta value can be defined to filter out delta measurements.

The value deltas remaining can be used in the AoD/SDD calculation. The result obtained using the AoD/SDD equation can be compared to a threshold value. The result obtained can be compared to one or more previous results (e.g., one or more of the most recent previous results). An alert can be transmitted to proper personnel if the result is greater than the threshold. The alert can indicate how much over the threshold the AoD/SDD value is and/or if the AoD/SDD is greater or less than a previous AoD/SDD value.

The time delta range and the maximum and minimum values are merely examples and the time delta range and the maximum and minimum values can be different values, such as for the same or different analyte. The time delta range can be chosen so as to reduce the incorporation of patients with increased biologic variation or to keep the biologic variation relatively stable. The value delta range can be set so as to reduce the influence of outlying values on the AoD/SDD calculation, such as to help increase the accuracy of the AoD/SDD calculation.

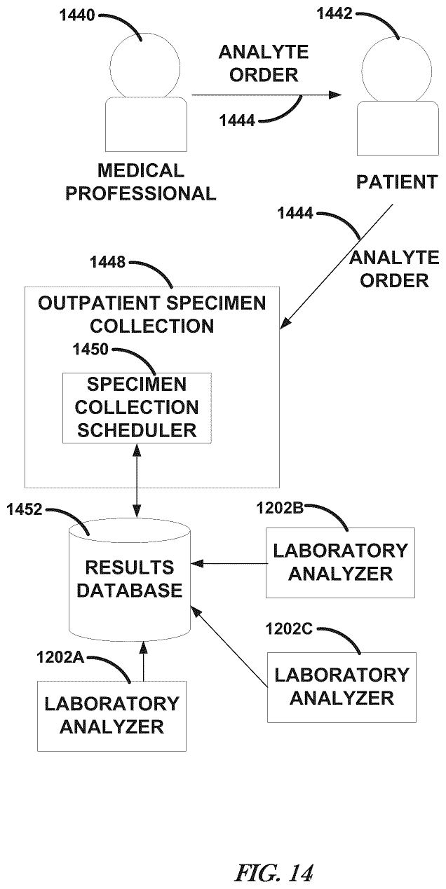

FIG. 14 illustrates, by way of example, a diagram of a system for scheduling an analyte measurement in a manner that helps minimize biologic variation between sequential samples. In a typical outpatient setting, a medical professional 1440 sees a patient 1442. The medical professional 1440 determines that they need more information to determine a diagnosis. The medical professional 1440 thus provides the patient with a draw request, called an analyte order 1444 in FIG. 14. The analyte order 1444 is a request to collect and analyze one or more specimens. The patient 1442 takes the analyte order 1444 to an outpatient laboratory 1448. The outpatient laboratory 1448 leverages a specimen collection scheduler 1450. The specimen collection scheduler 1450 includes a computer configured to determine a best time and date at which to collect the sample from the user to minimize biologic variation. The specimen collection scheduler 1450 can determine a date, time, and laboratory analyzer 1202A, 1202B, or 1202C of a most recent same analyte specimen collection from the patient 1442. The specimen collection scheduler 1450 can consult the results database 1452 to make such a determination. The results database 1452 includes historical records of respective times, dates, and laboratory analyzers that were used to collect and analyze the analytes of the patient 1442 (and other patients). The specimen collection scheduler 1450 can, if possible, schedule the specimen collection on a same day of week, about a same time (e.g., previous time plus or minus a few hours), in a same season (e.g., within 88 days, 28 days, regardless of the year, or the like), or a combination thereof, as the previous specimen collection. The specimen collection scheduler 1450 can schedule analysis of the specimen for a same laboratory analyzer 1202A-C that analyzed the immediately previous sample. By scheduling in this way, the specimen collection scheduler 1450 can reduce the natural biologic variation of the patient 1442 and make the comparison of the consecutive specimen draw results as meaningful as possible.

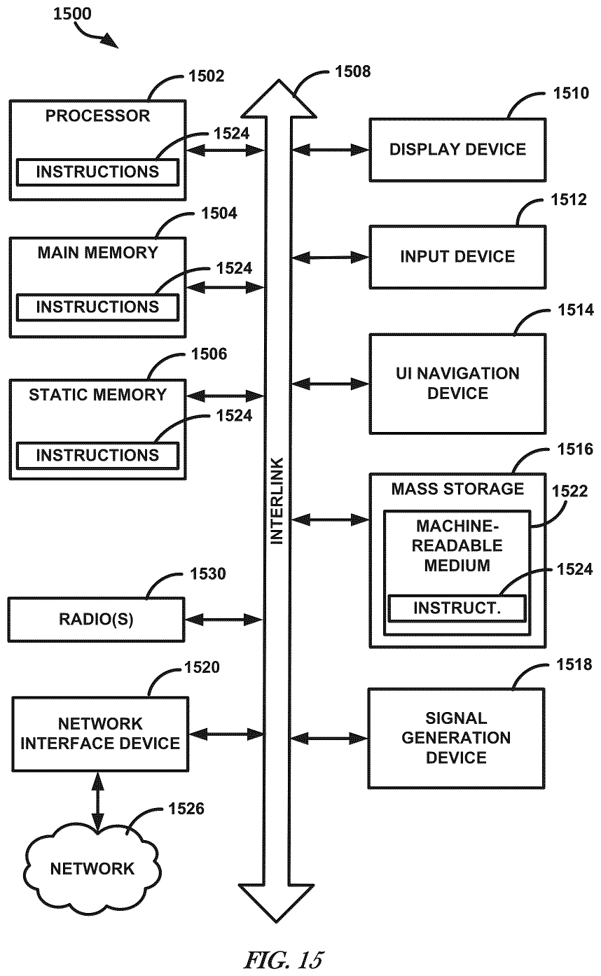

FIG. 15 illustrates, by way of example, a block diagram of an example of a device 1500 upon which any of one or more processes (e.g., methods) discussed herein can be performed. The device 1500 (e.g., a machine) can operate so as to perform one or more of the programming or communication processes (e.g., methodologies) discussed herein. In some examples, the device 1500 can operate as a standalone device or can be connected (e.g., networked) to one or more items of the system 1200, such as the laboratory analyzer 1202, the AoD module 1204, the filter module 1210, the compare module 1214, and/or the alert module 1218. An item of the system 1200 or the system of FIG. 14 can include one or more of the items of the device 1500. For example one or more of the laboratory analyzer 1202, the AoD module 1204, the filter module 1210, the compare module 1214, the alert module 1218, and/or the specimen collection scheduler 1450 can include one or more of the items of the device 1500.

Embodiments, as described herein, can include, or can operate on, logic or a number of components, modules, or mechanisms. Modules are tangible entities (e.g., hardware) capable of performing specified operations when operating A module includes hardware. In an example, the hardware can be specifically configured to carry out a specific operation (e.g., hardwired). In an example, the hardware can include configurable execution units (e.g., transistors, logic gates (e.g., combinational and/or state logic), circuits, etc.) and a computer readable medium containing instructions, where the instructions configure the execution units to carry out a specific operation when in operation. The configuring can occur under the direction of the executions units or a loading mechanism. Accordingly, the execution units can be communicatively coupled to the computer readable medium when the device is operating. In this example, the execution units can be a user of more than one module. For example, under operation, the execution units can be configured by a first set of instructions to implement a first module at one point in time and reconfigured by a second set of instructions to implement a second module.

Device (e.g., computer system) 1500 can include a hardware processor 1502 (e.g., a central processing unit (CPU), a graphics processing unit (GPU), a hardware processor core, processing circuitry (e.g., logic gates, multiplexer, state machine, a gate array, such as a programmable gate array, arithmetic logic unit (ALU), or the like), or any combination thereof), a main memory 1504 and a static memory 1506, some or all of which can communicate with each other via an interlink (e.g., bus) 1508. The device 1500 can further include a display unit 1510, an input device 1512 (e.g., an alphanumeric keyboard), and a user interface (UI) navigation device 1514 (e.g., a mouse). In an example, the display unit 1510, input device 1512 and UI navigation device 1514 can be a touch screen display. The device 1500 can additionally include a storage device (e.g., drive unit) 1516, a signal generation device 1518 (e.g., a speaker), and a network interface device 1520. The device 1500 can include an output controller 1528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1516 can include a machine readable medium 1522 on which is stored one or more sets of data structures or instructions 1524 (e.g., software) embodying or utilized by any one or more of the techniques or functions described herein. The instructions 1524 can also reside, completely or at least partially, within the main memory 1504, within static memory 1506, or within the hardware processor 1502 during execution thereof by the device 1500. In an example, one or any combination of the hardware processor 1502, the main memory 1504, the static memory 1506, or the storage device 1516 can constitute machine readable media.

While the machine readable medium 1522 is illustrated as a single medium, the term “machine readable medium” can include a single medium or multiple media (e.g., a centralized or distributed database, and/or associated caches and servers) configured to store the one or more instructions 1524. The term “machine readable medium” can include any tangible medium that is capable of storing, encoding, or carrying instructions for execution by the device 1500 and that cause the device 1500 to perform any one or more of the techniques (e.g., processes) of the present disclosure, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media can include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks. A machine readable medium does not include signals per se.

The instructions 1524 can further be transmitted or received over a communications network 1526 using a transmission medium via the network interface device 1520 utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 1520 can include one or more physical jacks (e.g., Ethernet, coaxial, or phone jacks) or one or more antennas to connect to the communications network 1526. In an example, the network interface device 1520 can include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the device 1500, and includes digital or analog communications signals or other intangible medium to facilitate communication of such software.

### Examples and Notes

The present subject matter may be described by way of several examples.

Example 1 may include or use subject matter (such as an apparatus, a method, a means for performing acts, or a device readable memory including instructions that, when performed by the device, may cause the device to perform acts), such as may include or use determining a time delta between consecutive measurements of an analyte made on a patient using a laboratory analyzer, determining whether the time delta is within a specified number of days window, a specified time of day window, and is within a same season, determining a measurement value delta between the first and second measurements of the consecutive measurements if the time delta is within the specified number of days, time of day windows, and the same season, calculating an average of deltas, the average of deltas including a measurement value delta between the consecutive measurements, determining whether the average of deltas is within a specified range of acceptable average of delta values, and issuing an alert if the average of deltas is not within the specified range of acceptable average of delta values.

Example 2 may include or use, or may optionally be combined with the subject matter of Example 1 to include or use, wherein the same season is within 29 days of the first measurement.

Example 3 may include or use, or may optionally be combined with the subject matter of Example 2 to include or use, wherein the same season is further defined as within modulo 29 days of the first measurement, wherein modulo retains days and removes years.

Example 4 may include or use, or may optionally be combined with the subject matter of Example 3 to include or use, determining a running Dahlberg's analysis of the values for which the time delta is within the specified number of days, time of day windows, and the same season resulting in a Dahlberg variation, determining the Dahlberg variation is greater than a specified threshold, and calibrating the laboratory analyzer if the Dahlberg variation is greater than the specified threshold and the average of deltas is not within the specified range of acceptable average of delta values.

Example 5 may include or use, or may optionally be combined with the subject matter of Example 4 to include or use, wherein the specified number of days window is an integer multiple of seven days.

Example 6 may include or use, or may optionally be combined with the subject matter of one of Examples 1-5 to include or use, wherein the consecutive measurements include a first measurement and a second measurement and the method further comprises comparing the second measurement to a range of acceptable measurement values and discarding the second measurement if the second sample is not within the range of acceptable measurement values.

Example 7 may include or use, or may optionally be combined with the subject matter of one of Examples 1-6 to include or use, wherein determining whether the average of deltas is within a specified range of acceptable average of delta values includes comparing a standard deviation of a plurality of consecutive average of delta values to a threshold standard deviation value and the method further comprises determining the laboratory analyzer is to be calibrated in response to determining the standard deviation is greater than the threshold standard deviation.

The above detailed description includes references to the accompanying drawings, which form a part of the detailed description. The drawings show, by way of illustration, specific embodiments in which methods, apparatuses, and systems discussed herein may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

As used herein, a “-” (dash) used when referring to a reference number means “or”, in the non-exclusive sense discussed in the previous paragraph, of all elements within the range indicated by the dash. For example, 103A-B means a nonexclusive “or” of the elements in the range {103A, 103B}, such that 103A-103B includes “103A but not 103B”, “103B but not 103A”, and “103A and 103B”.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

What is claimed is:

1. A method comprising:
determining a time delta between consecutive measurements of an analyte made on a patient using a laboratory analyzer;
determining whether the time delta is within a specified number of days window, a specified time of day window, and is within a same season;
determining a measurement value delta between the first and second measurements of the consecutive measurements if the time delta is within the specified number of days, time of day windows, and the same season;
calculating an average of deltas, the average of deltas including a measurement value delta between the consecutive measurements;
determining whether the average of deltas is within a specified range of acceptable average of delta values; and
issuing an alert if the average of deltas is not within the specified range of acceptable average of delta values.

2. The method of claim 1, wherein the same season is within 29 days of the first measurement.

3. The method of claim 2, wherein the same season is further defined as within modulo 29 days of the first measurement, wherein modulo retains days and removes years.

4. The method of claim 1, further comprising:
determining a running Dahlberg's analysis of the values for which the time delta is within the specified number of days, time of day windows, and the same season resulting in a Dahlberg variation;
determining the Dahlberg variation is greater than a specified threshold; and
calibrating the laboratory analyzer if the Dahlberg variation is greater than the specified threshold and the average of deltas is not within the specified range of acceptable average of delta values.

5. The method of claim 1, wherein the specified number of days window is an integer multiple of seven days.

6. The method of claim 1, wherein the consecutive measurements include a first measurement and a second measurement and the method further comprises comparing the second measurement to a range of acceptable measurement values and discarding the second measurement if the second sample is not within the range of acceptable measurement values.

7. The method of claim 1, wherein determining whether the average of deltas is within a specified range of acceptable average of delta values includes comparing a standard deviation of a plurality of consecutive average of delta values to a threshold standard deviation value and the method further comprises determining the laboratory analyzer is to be calibrated in response to determining the standard deviation is greater than the threshold standard deviation.

8. A system comprising:
a processor;
an average of deltas (AoD)) module, stored on a memory and executable by the processor, that:
receives pairs of consecutive measurement values of an analyte of one or more patients, each pair of consecutive measurement values including a first measurement of an analyte obtained from a patient of the one or more patient at a first time and a second measurement of an analyte obtained from the patient at a second time after the first time;
determines a time of day delta and a number of days delta between each pair of consecutive measurement values;
determines whether the time of day delta is within a specified time of day window, the number of days delta is within a specified number of days window, and a same season;
determines a measurement value deltas between each pair of consecutive measurement values that includes a time of day delta within the specified time of day window, the number of days delta within the number of days window and the same season; and
determines an AoD using the determined measurement value deltas; and
a compare module, executable by the processor, that compares the determined AoD to a range of acceptable AoDs and whether a laboratory analyzer that performed the duplicate measurements needs to be re-calibrated based on the comparison.

9. The system of claim 8, wherein the same season is within 29 days of the first measurement.

10. The system of claim 9, wherein the same season is further defined as within modulo 29 days of the first measurement, wherein modulo retains days and removes years.

11. The system of claim 8, wherein the processor further:
determines a running Dahlberg's analysis of the values for which the time delta is within the specified number of days, time of day windows, and the same season resulting in a Dahlberg variation;
determines the Dahlberg variation is greater than a specified threshold; and
calibrates the laboratory analyzer if the Dahlberg variation is greater than the specified threshold and the average of deltas is not within the specified range of acceptable average of delta values.

12. The system of claim 8, wherein the specified number of days window is an integer multiple of seven days.

13. The system of claim 8, wherein the consecutive measurements include a first measurement and a second measurement and the method further comprises comparing the second measurement to a range of acceptable measurement values and discarding the second measurement if the second sample is not within the range of acceptable measurement values.

14. The system of claim 8, wherein determining whether the average of deltas is within a specified range of acceptable average of delta values includes comparing a standard deviation of a plurality of consecutive average of delta values to a threshold standard deviation value and the method further comprises determining the laboratory analyzer is to be calibrated in response to determining the standard deviation is greater than the threshold standard deviation.

15. A machine readable storage device comprising instructions stored thereon, which when executed by the machine, cause the machine to perform operations comprising:
determining a time delta between consecutive measurements of an analyte made on a patient using a laboratory analyzer;
determining whether the time delta is within a specified number of days window, a specified time of day window, and is within a same season;
determining a measurement value delta between the first and second measurements of the consecutive measurements if the time delta is within the specified number of days, time of day windows, and the same season;
calculating an average of deltas, the average of deltas including a measurement value delta between the consecutive measurements,
determining whether the average of deltas is within a specified range of acceptable average of delta values; and
issuing an alert if the average of deltas is not within the specified range of acceptable average of delta values.

16. The machine readable storage device of claim 15, wherein the same season is within 29 days of the first measurement.

17. The machine readable storage device of claim 16, wherein the same season is further defined as within modulo 29 days of the first measurement, wherein modulo retains days and removes years.

18. The machine readable storage device of claim 15, wherein the operations further comprise:
determining a running Dahlberg's analysis of the values for which the time delta is within the specified number of days, time of day windows, and the same season resulting in a Dahlberg variation;
determining the Dahlberg variation is greater than a specified threshold; and
calibrating the laboratory analyzer if the Dahlberg variation is greater than the specified threshold and the average of deltas is not within the specified range of acceptable average of delta values.

19. The machine readable storage device of claim 15, wherein the specified number of days window is an integer multiple of seven days.

20. The machine readable storage device of claim 15, wherein the consecutive measurements include a first measurement and a second measurement and the method further comprises comparing the second measurement to a range of acceptable measurement values and discarding the second measurement if the second sample is not within the range of acceptable measurement values.
